(19) United States
(12) Patent Application Publication
(10) Pub. No.: US 2024/0031884 A1
(43) Pub. Date: Jan. 25, 2024

(54) TERMINAL AND RADIO COMMUNICATION SYSTEM

(71) Applicant: NTT DOCOMO, INC., Tokyo (JP)

(72) Inventor: Tianyang Min, Tokyo (JP)

(73) Assignee: NTT DOCOMO, INC., Tokyo (JP)

(21) Appl. No.: 18/042,132

(22) PCT Filed: Aug. 18, 2021
(86) PCT No.: PCT/JP2021/030157

§ 371 Date: Feb. 17, 2023

(30) Foreign Application Priority Data
Aug. 20, 2020 (JP) 2020-139263

(51) Int. Cl. H04W 36/00

(52) U.S. Cl. CPC H04W 36/0069

(57) ABSTRACT

The UE transmits and receives a message of the radio resource control layer. The UE transmits dual connectivity information including a radio resource control layer reconfiguration message to the network in a secondary cell addition or modification procedure.

### TECHNICAL FIELD

The present invention relates to a terminal and a radio communication system for transmitting and receiving messages of a radio resource control layer.

### BACKGROUND ART

3rd Generation Partnership Project (3GPP) specifies 5th generation mobile communication system (5G, also called New Radio (NR) or Next Generation (NG), further, a succeeding system called Beyond 5G, 5G Evolution or 6G is being specified.

For example, in Release-17 of 3 GPP, expansion of Multi-RAT Dual Connectivity (MR-DC) is being considered (Non-Patent Literature 1). Concretely, in order to realize more efficient addition or change of Primary SCell (PSCell), support of a conditional secondary cell (secondary node) addition/change procedure with a simplified procedure is being studied.

### CITATION LIST

### Non-Patent Literature

Non-Patent Literature 1 “Revised WID on Further Multi-RAT Dual-Connectivity enhancements”, RP-201040, 3 GPP TSG RAN Meeting #88 e, 3 GPP, June 2020

### SUMMARY OF INVENTION

However, the above-mentioned conditional PSCell addition/change has the following problems. For example, in the case of E-UTRA-NR Dual Connectivity (EN-DC), it is difficult to directly transmit the NR radio resource control layer (RRC) message (RRC Reconfiguration Complete) to the eNB that is the master node (MN).

Further, when the MN (eNB) receives the RRC Reconfiguration Complete from the terminal (User Equipment, UE), the MN cannot determine to which target secondary node (T-SN) the SgNB Reconfiguration Complete should be transmitted. Also, the MN cannot determine which T-SN the UE has accessed.

Accordingly, the following disclosure has been made in view of such a situation, and it is an object of the present invention to provide a terminal and an radio communication system capable of surely adding or changing a conditional secondary cell (secondary node) even when a procedure for adding or changing the secondary cell is applied in dual connectivity.

One aspect of the present disclosure a terminal (UE 200) including a transmission/reception unit (RRC processing unit 220) that transmits and receives messages of a radio resource control layer. The transmission/reception unit transmits dual connectivity information including a reconfiguration message of the radio resource control layer to a network in a procedure for adding or changing a secondary cell.

One aspect of the present disclosure is a terminal (UE 200) including a transmission/reception unit (RRC processing unit 220) that transmits and receives messages of a radio resource control layer. The transmission/reception unit transmits another message of the radio resource control layer including a reconfiguration message of the radio resource control layer to a network in a procedure for adding or changing a secondary cell.

### BRIEF DESCRIPTION OF DRAWINGS

FIG. 1 is an overall schematic diagram of a radio communication system 10.

FIG. 2 is a functional block diagram of the eNB 100 A.

FIG. 3 is a functional block diagram of the UE 200.

FIG. 4 is a diagram showing an example of a communication sequence (late data forwarding) according to a conventional conditional PSCell addition procedure.

FIG. 5 is a diagram showing an example of a communication sequence (early data forwarding) according to a conventional conditional PSCell addition procedure.

FIG. 6 is a diagram showing an example of a communication sequence (late data forwarding) according to a conditional inter-SN PSCell change procedure (SN-initiated conditional inter-SN PSCell change) initiated by an SN.

FIG. 7 is a diagram showing an example of a part of a communication sequence using the ULInformation Transfer MRDC according to the operation example 1.

FIG. 8 is a diagram showing an example of a portion of a communication sequence using a new RRC message according to operation example 2.

FIG. 9 is a diagram showing a configuration example of the CondReconfigToAddModList.

FIG. 10 is a diagram showing an example configuration of an NR ULInformationTransferMRDC message.

FIG. 11 is a diagram showing an example configuration of an LTE ULInformation Transfer MRDC message.

FIG. 12 is a diagram showing an example of the hardware configuration of the eNB 100 A, gNB 100 B and UE 200.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

### (1) Overall Schematic Configuration of the Radio Communication System

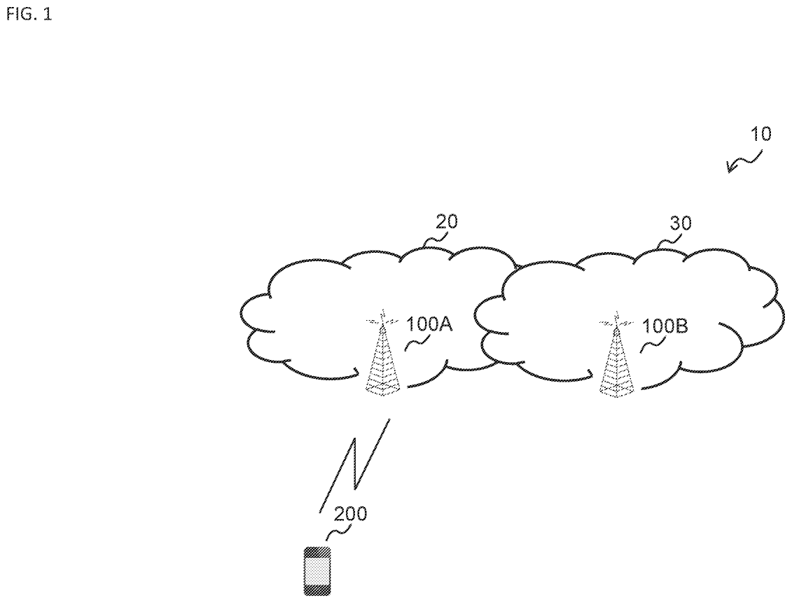

FIG. 1 is an overall schematic configuration diagram of a radio communication system 10 according to this embodiment. The radio communication system 10 is radio communication system according to Long Term Evolution (LTE) and 5G New Radio (NR). Note that LTE may be referred to as 4G and NR may be referred to as 5G. The radio communication system 10 may also be a radio communication system following a scheme called Beyond 5G, 5G Evolution or 6G.

LTE and NR may be interpreted as radio access technologies (RAT), and in this embodiment, LTE may be referred to as a first radio access technology and NR may be referred to as a second radio access technology.

The radio communication system 10 includes the Evolved Universal Terrestrial Radio Access Network 20 (E-UTRAN 20) and the Next Generation-Radio Access Network 30 (hereinafter NG RAN 30). The radio communication system 10 also includes a terminal 200 (UE 200, User Equipment).

The E-UTRAN 20 includes an eNB 100 A which is a radio base station according to LTE. NG RAN 30 includes gNB 100 B which is a radio base station in accordance with 5 G (NR). The E-UTRAN 20 and the NG RAN 30 (which may be eNB 100 A or gNB 100 B) may simply be referred to as a network.

The eNB 100 A, the gNB 100 B, and the UE 200 can support carrier aggregation (CA) using a plurality of component carriers (CCs), dual connectivity for simultaneously transmitting component carriers between a plurality of NG-RAN nodes and the UE, and the like.

The eNB 100 A, gNB 100 B and UE 200 perform radio communication via a radio bearer, specifically, a Signalling Radio Bearer (SRB) or a Data Radio Bearer (DRB).

In this embodiment, the eNB 100 A configures the master node (MN) and the gNB 100 B configures the secondary node (SN) to execute Multi-Radio Dual Connectivity (MR-DC), specifically, E-UTRA-NR Dual Connectivity (EN-DC).

That is, the UE 200 corresponds to dual connectivity connecting the eNB 100 A and the gNB 100 B.

The eNB 100 A is included in the master cell group (MCG), and the gNB 100 B is included in the secondary cell group (SCG). That is, the gNB 100 B is an SN included in the SCG.

The eNB 100 A and gNB 100 B may be referred to as radio base stations or network devices.

In addition, conditional PSCell addition/change of Primary SCell (PSCell) may be supported in radio communication system 10. PSCell is a type of secondary cell. PSCell means Primary SCell (secondary cell), and it may be interpreted that any SCell among a plurality of SCells corresponds to it.

The secondary cell may be read as a secondary node (SN) or a secondary cell group (SCG). Conditional PSCell addition/change may allow efficient and rapid addition or modification of secondary cells.

The conditional PSCell addition/change may be interpreted as a simplified conditional secondary cell addition/change procedure.

The radio communication system 10 may also support conditional inter-SN PSCell change procedures. Specifically, MN-initiated conditional inter-SN PSCell change and/or SN-initiated conditional inter-SN PSCell change may be supported.

### (2) Function Block Configuration of Radio Communication System

Next, the functional block configuration of radio communication system 10 will be described. Specifically, the functional block configurations of the eNB 100 A and the UE 200 will be described.

(2.1) eNB100A

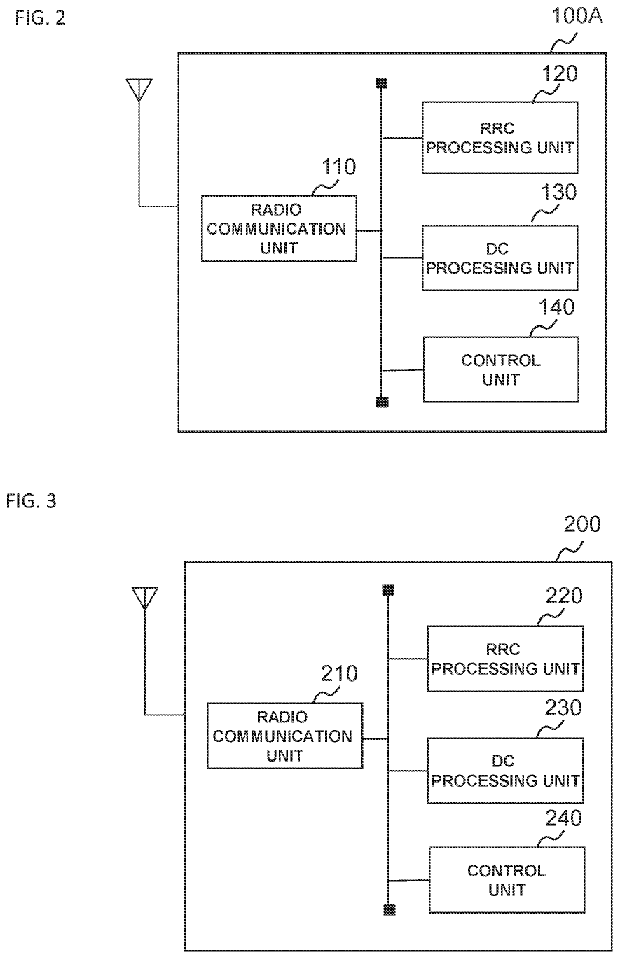

FIG. 2 is a functional block diagram of the eNB 100 A. As shown in FIG. 2, the eNB 100 A includes a radio communication unit 110, an RRC processing unit 120, a DC processing unit 130, and a control unit 140.

The radio communication unit 110 transmits a downlink signal (DL signal) in accordance with LTE. The radio communication unit 110 receives an uplink signal (UL signal) in accordance with LTE.

The RRC processing unit 120 executes various processes in the radio resource control layer (RRC). Specifically, the RRC processing unit 120 can transmit the RRC Reconfiguration to the UE 200. The RRC processing unit 120 can receive the RRC Reconfiguration Complete, which is a response to the RRC Reconfiguration, from the UE 200.

In this embodiment, the eNB 100 A supports LTE, but in this case, the name of the RRC message may be RRC Connection Reconfiguration or RRC Connection Reconfiguration Complete.

The RRC processing unit 120 may include the cell ID of the target PSCell, for example, the cell global identifier (CGI), for each condReconfigld in the conditional Reconfiguration included in the RRC Reconfiguration. The UE 200 may configure the RRC layer by such Conditional Reconfiguration. Note that, instead of the CGI, information capable of identifying the SN (gNB 100 B) (which may be referred to as a gNB ID) may be used.

Further, the RRC processing unit 120 may determine the SN (T-SN) to be added or changed based on the cell ID (For example, NR Physical Cell ID (PCI), NR CGI, or gNB ID) contained in the ULInformation Transfer MRDC message transmitted from the UE 200.

Note that a new RRC message may be used instead of the ULInformationTransferMRDC message. The RRC message may be referred to as a bye-message.

As will be described later, SgNB Reconfiguration complete may be transmitted to the T-SN under the control of control unit 140. The control unit 140 may also specify the T-SN based on the cell ID of the target PSCell transmitted from the UE 200 and the frequency band in the NR.

The DC processing unit 130 executes processing related to dual connectivity, specifically, Multi-RAT Dual Connectivity (MR-DC). In this embodiment, since the eNB 100 A supports LTE and the gNB 100 B supports NR, the DC processing unit 130 may execute processing related to E-UTRA-NR Dual Connectivity (EN-DC). The type of DC is not limited, and may correspond to, for example, NR-E-UTRA Dual Connectivity (NE-DC) or NR-NR Dual Connectivity (NR-DC).

The DC processing unit 130 can transmit/receive a message specified in the 3 GPP TS 37.340 or the like, and execute processing related to setting and releasing DC between the eNB 100 A, the gNB 100 B and the UE 200.

The control unit 140 controls each functional block constituting the eNB 100 A. In particular, in the present embodiment, the control for adding or changing the secondary node is executed.

Specifically, control unit 140 can decide whether or not to execute the conditional PSCell addition/change (CPA/CPC) based on the measurement report from the UE 200.

When control unit 140 determines the CPA/CPC, it may send an SN Addition Request to the target secondary node (T-SN). The control unit 140 may also receive an SN Addition Request Ack, which is a response to the SN Addition Request, from the T-SN.

Also, the control unit 140 may receive not only the CPA/CPC but also the SN change required from the S-SN when the source secondary node (S-SN) has determined the SN-initiated conditional inter-SN PSCell change (CPC). The control unit 140 may also send an SN Addition Request to the T-SN in response to the SN change required.

In this embodiment, the channel includes a control channel and a data channel. The control channels include PDCCH (Physical Downlink Control Channel), PUCCH (Physical Uplink Control Channel), PRACH (Physical Random Access Channel), PBCH (Physical Broadcast Channel), and the like.

The data channels include PDSCH (Physical Downlink Shared Channel) and PUSCH (Physical Uplink Shared Channel).

The reference signals include a Demodulation reference signal (DMRS), a Sounding Reference Signal (SRS), a Phase Tracking Reference Signal (PTRS), and a Channel State Information-Reference Signal (CSI-RS). The data may refer to data transmitted via a data channel.

(2.2) UE200

FIG. 3 is a functional block diagram of the UE 200. As shown in FIG. 3, the UE 200 includes a radio communication unit 210, an RRC processing unit 220, a DC processing unit 230, and a control unit 240.

The radio communication unit 210 transmits an uplink signal (UL signal) in accordance with LTE or NR. The radio communication unit 210 receives an uplink signal (UL signal) in accordance with LTE. That is, the UE 200 can access the eNB 100 A (E-UTRAN 20) and the gNB 100 B (NG RAN 30), and can support dual connectivity (Specifically, EN-DC).

The RRC processing unit 220 executes various processes in the radio resource control layer (RRC). Specifically, the RRC processing unit 220 can transmit and receive messages of the radio resource control layer. In this embodiment, the RRC processing unit 220 constitutes a transmission/reception unit.

As described above, the RRC processor 220 can receive the RRC Reconfiguration from the network, specifically the E-UTRAN 20 (or NG RAN 30). The RRC processing unit 220 can transmit the RRC Reconfiguration Complete, which is a response to the RRC Reconfiguration, to the network.

In the present embodiment, the RRC processing unit 220 may transmit dual connectivity information including a radio resource control layer reconfiguration message to the network in a secondary cell addition/change procedure.

Specifically, the RRC processing unit 220 may transmit a ULInformationTransferMRDC message including RRC Reconfiguration Complete to the network. As described above, RRC Reconfiguration Complete may be RRC Connection Reconfiguration Complete.

A normal UL information transfer may be used instead of the ULInformationTransferMRDC.

Alternatively, in the conditional PSCell addition/change, the RRC processing unit 220 may transmit another message of the radio resource control layer including a reconfiguration message of the radio resource control layer to the network.

Specifically, the RRC processing unit 220 may transmit a new RRC message (bye-message) to the RRC layer including the RRC Reconfiguration Complete, or may use an existing message of the RRC layer to include the RRC Reconfiguration Complete (That is, it is embedded.).

Further, the RRC processing unit 220 may receive a message of the radio resource control layer including identification information of SCell (which may include PSCell) or a radio base station (gNB) forming the SCell.

Specifically, the RRC processing unit 220 may receive the RRC Reconfiguration including the CGI (or gNB ID) of the target PSCell as the identification information. In accordance with the received RRC Reconfiguration, the RRC processing unit 220 may transmit dual connectivity information including the CGI (or gNB ID), specifically, the ULInformationTransferMRDC message to the network.

Alternatively, the RRC processing unit 220 may transmit another message of the RRC layer including the CGI (or gNB ID), specifically, the new RRC message (bye-message) described above, to the network in accordance with the received RRC Reconfiguration.

The DC processing unit 230 executes processing related to dual connectivity, specifically, MR-DC. As described above, in the present embodiment, the DC processing unit 230 may execute processing relating to EN-DC, but may correspond to NE-DC and/or NR-DC.

The DC processing unit 230 accesses the eNB 100 A and the gNB 100 B, respectively, and can execute setting in a plurality of layers (Media access control layer (MAC), radio link control layer (RLC), and packet data convergence protocol layer (PDCP), etc.) including RRC.

The control unit 240 controls each functional block constituting the UE 200. In particular, in this embodiment, the control unit 240 executes transmission/reception of an RRC message by the RRC processing unit 220 and control concerning DC by the DC processing unit 230.

Specifically, control unit 240 may encode the cell ID (NR PCI, NR CGI or gNB ID) of the target PSCell that meets the conditions for addition or modification at the RRC layer of the LTE and send the ULInformationTransferMRDC message described above or a new RRC message (bye-message) to the network with RRC Reconfiguration Complete.

The encoding of the cell ID of the target PSCell may be interpreted as processing necessary for inclusion in a ULInformationTransferMRDC message or a new RRC message, or as dual connectivity information (ULInformationTransferMRDC) or an RRC message including the cell ID (identification information).

### (3) Operation of Radio Communication System

Next, the operation of radio communication system 10 will be described. Specifically, the operation of radio communication system 10 related to the conditional PSCell addition/change procedure and the conditional inter-SN PSCell change procedure (MN-initiated conditional inter-SN PSCell change/SN-initiated conditional inter-SN PSCell change) will be described.

### (3.1) Conventional Operation Examples and Problems

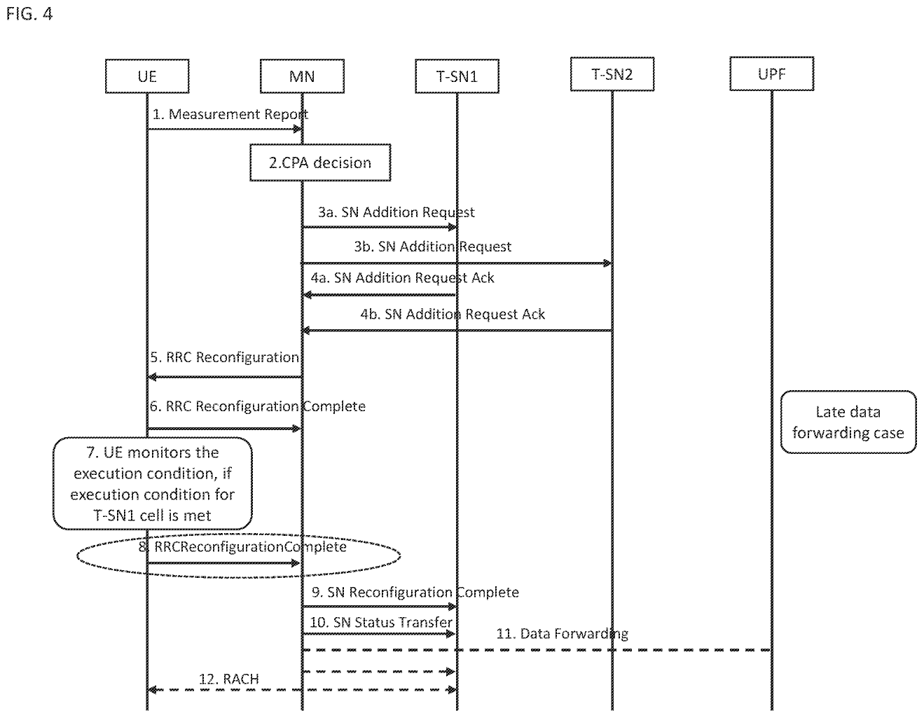

FIG. 4 shows an example of a communication sequence (late data forwarding) according to the conventional conditional PSCell addition procedure.

As shown in FIG. 4, in the conditional PSCell addition (CPA), the MN (eNB 100 A) determines the propriety (necessity) of CPA based on the measurement report from the UE 200 (step 2).

When the MN is eNB and the SN is gNB, if the UE 200 monitors the execution condition and there is a target PSCell that satisfies the execution condition, the UE 200 applies the RRC reset of the target PSCell and returns the RRC Reconfiguration Complete to the MN (steps 7 and 8) because it is necessary to send an RRC reset completion message to the SN via the MN.

However, the UE 200 does not know how to transmit the RRC Reconfiguration Complete of the NR to the eNB which is the MN (see the dotted line frame in FIG. 1), and therefore cannot transmit the RRC Reconfiguration Complete.

Further, if the MN (eNB) receives the RRC Reconfiguration Complete from the UE 200, the MN cannot determine to which target secondary node (T-SN) SgNB Reconfiguration Complete (which may be called SN Reconfiguration Complete) should be transmitted. Also, the MN cannot determine which T-SN the UE 200 has accessed.

This problem is not limited to the case of late data forwarding shown in FIG. 4, but is also the case of early data forwarding.

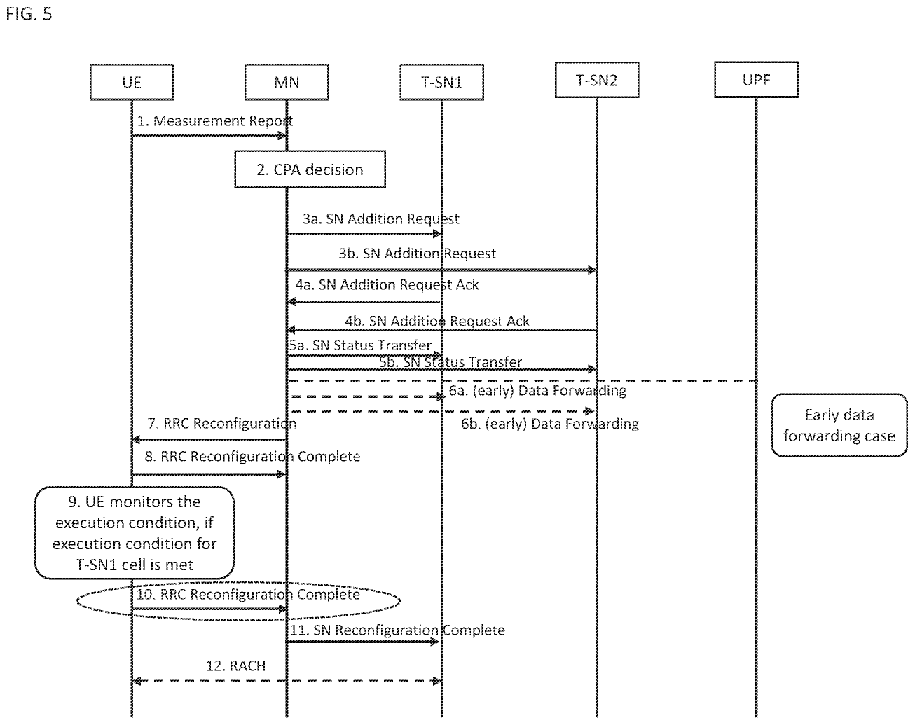

FIG. 5 shows an example of a communication sequence (early data forwarding) according to the conventional conditional PSCell addition procedure.

Also in the example shown in FIG. 5, the UE does not know how to transmit the RRC Reconfiguration Complete of the NR to the eNB which is the MN (see the dotted line frame in FIG. 5), and there is a problem that the UE 200 cannot transmit the RRC Reconfiguration Complete.

Such a problem is not limited to the conditional PSCell addition, but also applies to the conditional inter-SN PSCell change.

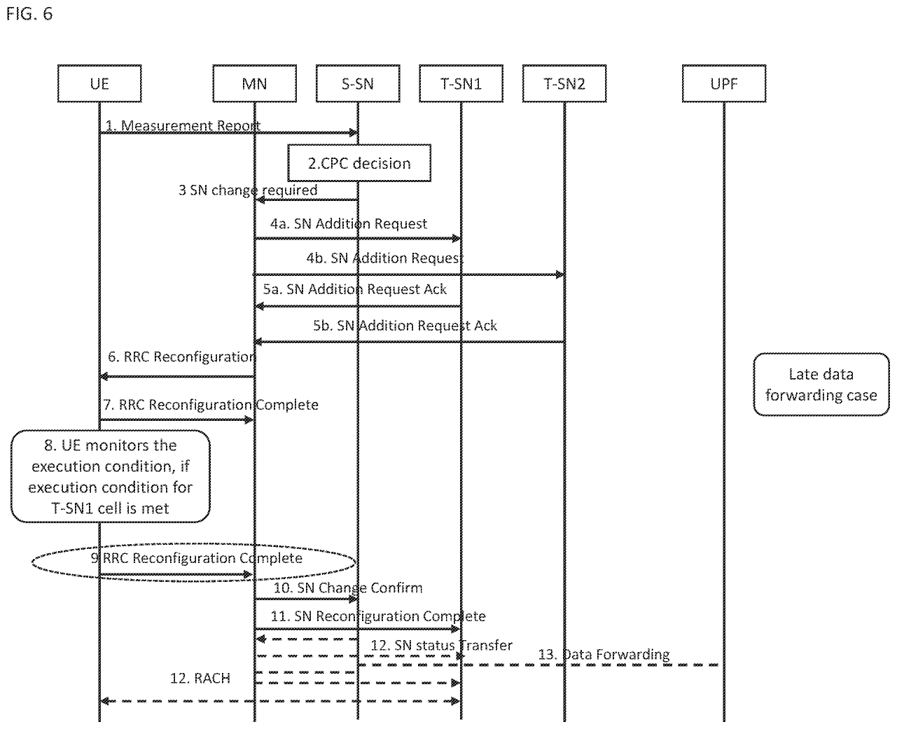

FIG. 6 shows an example of a communication sequence (late data forwarding) following the SN-initiated conditional inter-SN PSCell change procedure (SN-initiated conditional inter-SN PSCell change).

As shown in FIG. 6, in the conditional PSCell change (CPC), the S-SN determines the propriety (necessity) of the CPC based on the Measurement Report from the UE 200 (step 2).

Also in the example shown in FIG. 6, it is unknown how the UE 200 should transmit the RRC Reconfiguration Complete of the NR to the eNB as the MN (see the dotted line frame in FIG. 6), and there is a problem that the UE cannot transmit the RRC Reconfiguration Complete.

### (3.2) Example of Operation

The following describes some operation examples that can solve the problem of not being able to transmit the RRC Reconfiguration Complete of the NR described above.

### (3.2.1) Operation Example 1

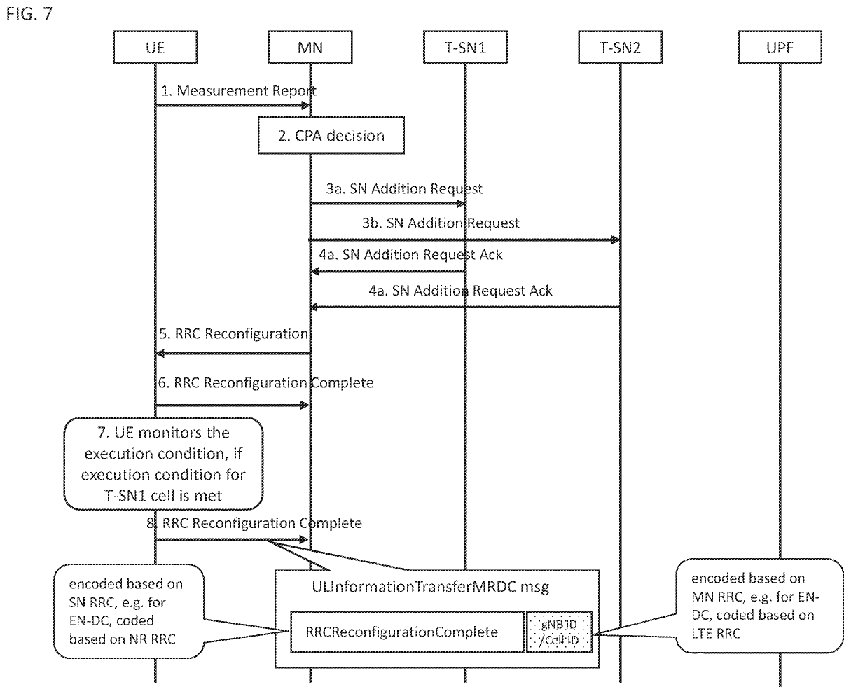

FIG. 7 shows a partial example of a communication sequence using the ULInformation Transfer MRDC according to the operation example 1. FIG. 7 corresponds to a communication sequence example (late data forwarding) according to the conditional PSCell addition shown in FIG. 4.

As shown in FIG. 7, the UE 200 may embed the NR RRC message, specifically the RRC Reconfiguration Complete, into the LTE ULInformation Transfer MRDC.

At this time, the UE 200 may include the cell ID (CGI, etc.) of the target PSCell (T-SN) or the identification information (gNB ID) of the gNB constituting the T-SN in the ULInformation Transfer MRDC.

Specifically, the UE 200 may encode the cell ID (NR PCI, NR CGI or gNB ID) of the target PSCell at the RRC layer of the LTE and transmit a ULInformationTransferMRDC message containing the RRC Reconfiguration Complete and the cell ID (or gNB ID).

FIG. 7 shows an example of late data forwarding, but the transmission of such a ULInformationTransferMRDC message including RRC Reconfiguration Complete is performed early as shown in FIG. 5.

May also be applied to data forwarding.

### (3.2.2) Example 2

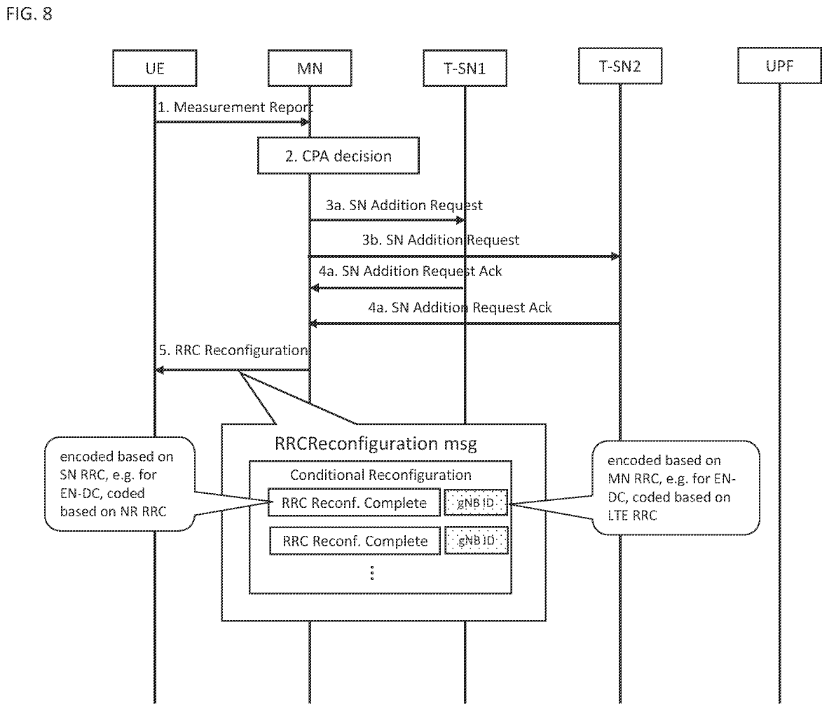

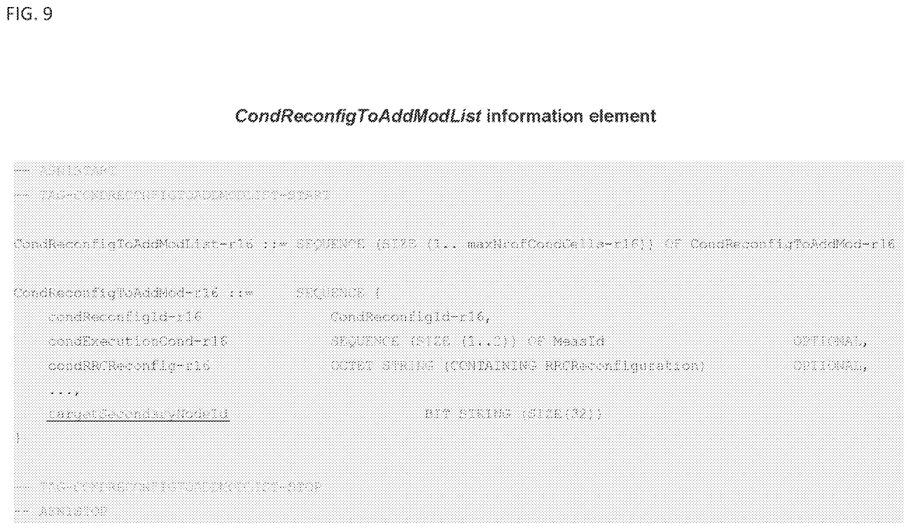

FIG. 8 shows a partial example of a communication sequence using the new RRC message according to the second operation example. FIG. 8 also corresponds to the communication sequence example (late data forwarding) according to the conditional PSCell addition shown in FIG. 4.

As shown in FIG. 8, the UE 200 may embed the NR RRC Reconfiguration Complete into a new LTE RRC message (which may be referred to as a Conditional Reconfiguration).

At this time, the UE 200 may include identification information (gNB ID) of the gNBs constituting the target PSCell (T-SN) in the Conditional Reconfiguration. The conditional reconfiguration may include a combination (pair) of a plurality of RRC reconfigurations and a gNB ID.

Furthermore, the cell ID (CGI, etc.) of the T-SN may be included instead of the gNB ID.

Although FIG. 8 also shows an example of late data forwarding, the transmission of Conditional Reconfiguration including Conditional Reconfiguration may be applied to the early data forwarding shown in FIG. 5.

### (3.2.3) Example 3

Next, in step 5 of the operation example 1 (FIG. 7) and the operation example 2 (FIG. 8) described above, the MN may include the cell ID (CGI, etc.) of the target PSCell for each condReconfigld in the ConditionalReconfiguration included in the RRC Reconfiguration. The UE 200 may configure the RRC layer based on the RRC Reconfiguration including such a cell ID.

Since the UE 200 needs to apply the RRC reconfiguration of the target PSCell and send an RRC reconfiguration completion message to the SN via the MN as described above, the cell ID (NR PCI, NR CGI or gNB ID) of the target PSCell satisfying the conditions of addition or modification may be encoded in the RRC layer of the LTE and the ULInformationTransferMRDC message or the new RRC message described above may be sent to the MN together with the RRC Reconfiguration Complete.

The MN (eNB 100 A) may specify the T-SN based on the cell ID (or gNB ID) of the target PSCell included in the ULInformation Transfer MRDC message or new RRC message (bye-message) transmitted from the UE 200 and the frequency band in the NR, and transmit SgNB Reconfiguration Complete to the specified T-SN.

Alternatively, the MN may specify the T-SN based on the PCI of the target PSCell transmitted from the UE 200 and the frequency band in the NR (which may be interpreted as an allocated frequency band (band) to the NR).

### (3.3) Configuration Examples of Information Elements and RRC Messages

Next, an example of the configuration of the information element (IE) of the RRC layer and the RRC message will be described.

FIG. 9 shows an example of the configuration of the CondReconfigToAddModList. IE CondReconfigToAddModList is specified in Section 3 GPP TS 38.331 6.3.2.

The IE CondReconfigToAddModList relates to a list of conditional reconfigurations to be added or modified, and for each entry, condReconfigId and associated condExecutionCond and condRRCReconfig are used, as shown in FIG. 9.

CondReconfigToAddModList may be interpreted as a configuration list of candidate Special Cells (SpCells) to be added or modified for conditional handover (CHO) or CPC.

In this embodiment, the field of the targetSecondaryNodeld (see the underlined portion) which is the identification information of the T-SN may be included.

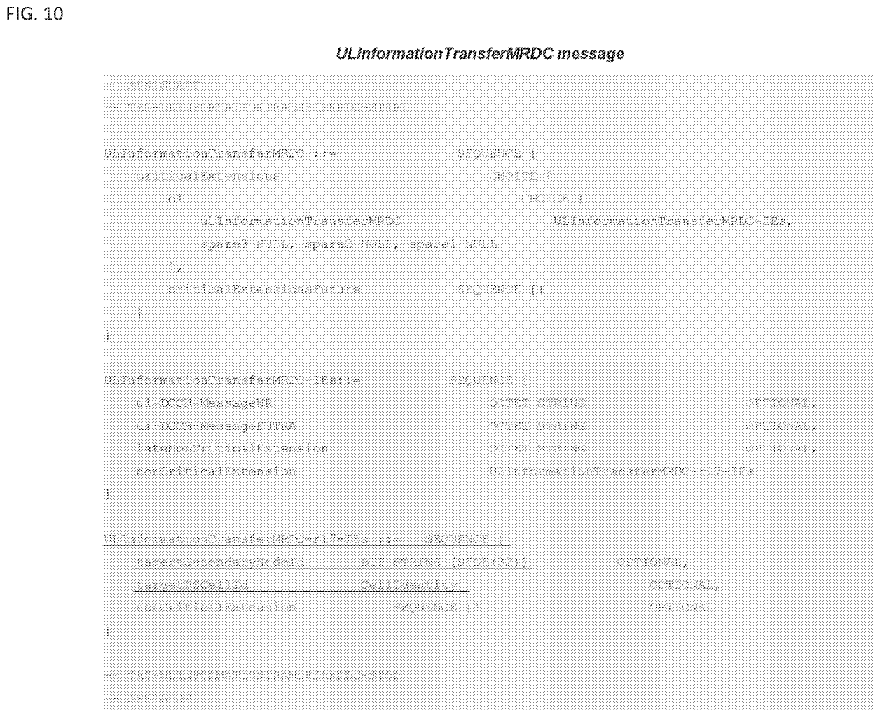

FIG. 10 shows an example of the configuration of the NR ULInformationTransferMRDC message. The NR ULInformation Transfer MRDC message is specified in Section 3 GPP TS 38.331 6.2.2.

As shown in FIG. 10, the NR ULInformationTransferMRDC message may include ULInformationTransferMRDC-r17-IEs as an information element. The IE may be supported in Release-17 of 3 GPP, as expressed as ULInformationTransferMRDC-r17-IEs, but may be supported in other releases.

The ULInformationTransferMRDC-r17-IEs may include the targetSecondaryNodeId and targetPSCellId fields (see underlined). targetPSCellId is the identity of the target PSCell (e.g. CGI).

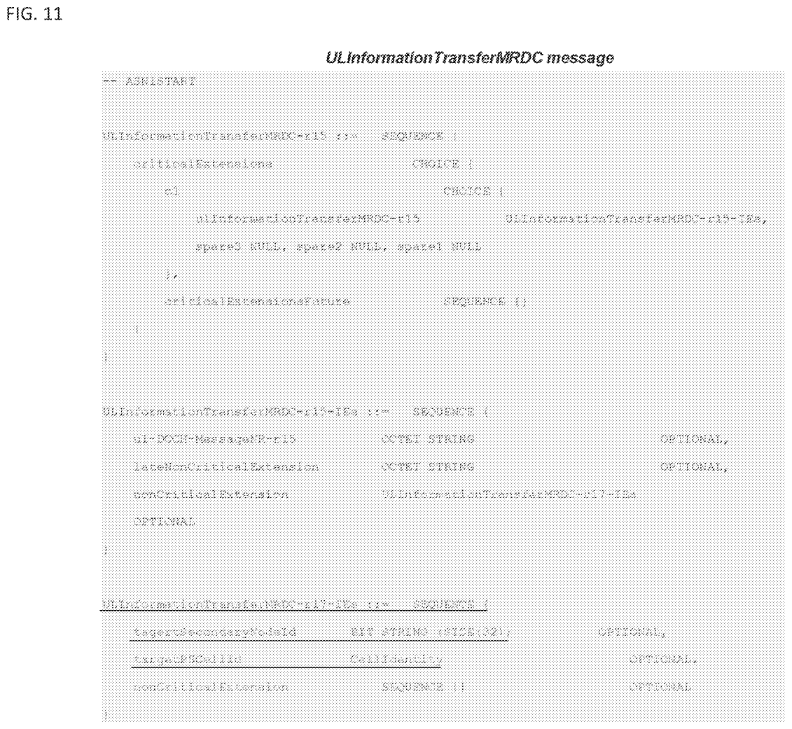

FIG. 11 shows a configuration example of the LTE ULInformationTransferMRDC message. The LTE ULInformation Transfer MRDC message is specified in Section 3 GPP TS 36.331 6.2.2.

As shown in FIG. 11, the configuration of the LTE ULInformationTransferMRDC message is generally similar to the configuration of the NR ULInformationTransferMRDC message shown in FIG. 10, and may include ULInformationTransferMRDC-r17-IEs. The ULInformationTransferMRDC-r17-IEs may include the targetSecondaryNodeId and targetPSCellId fields (see underlined).

### (4) Operational Effects

According to the embodiment described above, the following effects are obtained. Specifically, the UE 200 can send a ULInformationTransferMRDC message (dual connectivity information) including RRC Reconfiguration Complete (radio resource control layer reconfiguration message) to the network in a conditional PSCell addition/change procedure.

The UE 200 can also send another RRC layer message including RRC Reconfiguration Complete, for example, a new RRC message (bye-message) to the network in the conditional PSCell addition/change procedure.

Thus, even when conditional PSCell addition/change is applied in a particular dual connectivity, such as EN-DC, UE 200 may implement the addition or change of PSCell through an RRC message that the MN (eNB) can recognize.

That is, according to radio communication system 10, even when conditional PSCell addition/change is applied in a dual connectivity such as EN-DC, addition/change of PSCell can be reliably executed.

In this embodiment, the UE 200 can receive an RRC Reconfiguration (radio resource control layer message) containing SCell (which may include PSCell) or identification information (CGI or gNB ID) of a radio base station (gNB) forming the SCell and transmit a ULInformationTransferMRDC message containing the CGI (or gNB ID) to the network. Alternatively, the UE 200 can transmit another message of the RRC layer including the CGI (or gNB ID), specifically, the new RRC message (bye-message) described above, to the network.

Therefore, the MN (eNB 100 A) can easily and accurately determine the target PSCell (which may be referred to as T-SN) in the conditional PSCell addition/change.

### (5) Other Embodiments

Although the contents of the present invention have been described by way of the embodiments, it is obvious to those skilled in the art that the present invention is not limited to what is written here and that various modifications and improvements thereof are possible.

For example, in the above embodiment, EN-DC in which MN is eNB and SN is gNB has been described as an example, but other DC may be used as described above. Specifically, it may be NR-DC where MN is gNB and SN is gNB, or NE-DC where MN is gNB and SN is eNB.

If the MN is gNB and the SN is gNB (NR-DC), the UE 200 may apply the RRC Reconfiguration, encode the cell ID (NR PCI, NR CGI or gNB ID) of the target PSCell satisfying the conditions of addition or modification in the RRC layer of the NR, and transmit the RRC Reconfiguration Complete in the ULInformationTransferMRDC message or the new RRC message (bye-message) described above.

Alternatively, if the MN is gNB and the SN is eNB (NE-DC), the UE 200 may apply the RRC Connection Reconfiguration, encode the cell ID (NR PCI, NR CGI or gNB ID) of the target PSCell that satisfied the conditions of addition or modification in the RRC layer of the NR, and transmit the RRC Connection Reconfiguration Complete in the ULInformationTransferMRDC message or new RRC message described above.

In the above embodiment, the conditional PSCell addition/change is mainly described as an example, but as described above, the same operation may be applied to the conditional inter-SN PSCell change procedure (MN-initiated conditional inter-SN PSCell change/SN-initiated conditional inter-SN PSCell change).

Further, the block configuration diagrams (FIGS. 2 and 3) used for the description of the above-described embodiment show blocks in units of functions. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that functions the transmission is called a transmission unit (transmitting unit) or a transmitter. As described above, there is no particular limitation on the method of implementation.

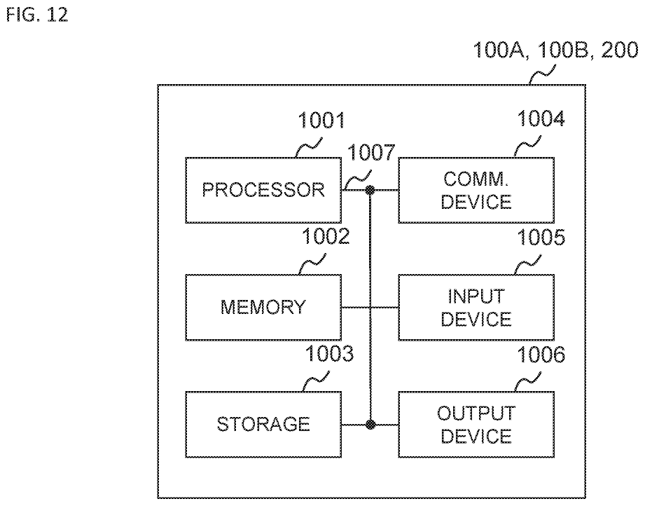

Further, the above-mentioned eNB 100 A, gNB 100 B and UE 200 (the apparatus) may function as a computer that performs processing of the radio communication method of the present disclosure. FIG. 12 is a diagram showing an example of a hardware configuration of the apparatus. As shown in FIG. 12, the device may be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the device (see FIG. 2.3) is implemented by any hardware element or combination of hardware elements of the computer device.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001 operates, for example, an operating system to control the entire computer. Processor 1001 may comprise a central processing unit (CPU) including interfaces to peripheral devices, controllers, arithmetic units, registers, and the like.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. Memory 1002 may be referred to as a register, cache, main memory, or the like. The memory 1002 may store programs (program codes), software modules, and the like that are capable of executing the method according to one embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Devices such as the processor 1001 and the memory 1002 are connected by a bus 1007 for communicating information. The bus 1007 may be configured using a single bus or may be configured using different buses for each device.

In addition, the device may comprise hardware such as a microprocessor, a digital signal processor (DSP), an application specific integrated circuit (ASIC), a programmable logic device (PLD), a field programmable gate array (FPGA), and the hardware may implement some or all of each functional block. For example, the processor 1001 may be implemented by using at least one of these hardware.

Further, the notification of the information is not limited to the mode/embodiment described in the present disclosure, and other methods may be used. For example, notification of information may be performed by physical layer signaling (e.g., Downlink Control Information (DCI), Uplink Control Information (UCI), higher layer signaling (e.g., RRC signaling, Medium Access Control (MAC) signaling, broadcast information (Master Information Block (MIB), System Information Block (SIB)), other signals, or a combination thereof. The RRC signaling may also be referred to as an RRC message, for example, an RRC Connection Setup message, an RRC Connection Reconfiguration message, and the like.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, and the like of each aspect/embodiment described in the present disclosure may be changed in order as long as there is no contradiction. For example, the methods described in this disclosure use an exemplary sequence to present the elements of the various steps and are not limited to the particular sequence presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each of the aspects/embodiments described in the present disclosure may be used alone, in combination, or switched over in accordance with implementation. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channel and the symbol may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS)”, “user terminal”, “user equipment (User Equipment: UE)”, “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile body may be a vehicle (For example, cars, planes, etc.), an unmanned mobile body (Drones, self-driving cars, etc.), or a robot (manned or unmanned). At least one of a base station and a mobile station can be a device that does not necessarily move during the communication operation. For example, at least one of a base station and a mobile station may be an Internet of Things (IoT) device such as a sensor.

The base station in the present disclosure may be read as a mobile station (user terminal). For example, each aspect/embodiment of the present disclosure may be applied to a configuration in which communication between a base station and a mobile station is replaced with communication between a plurality of mobile stations (For example, it may be called Device-to-Device (D2D), Vehicle-to-Everything (V2X), etc.). In this case, the mobile station may have the function of the base station. In addition, words such as “up” and “down” may be replaced with words corresponding to communication between terminals (For example, “side”.). For example, terms an uplink channel, a downlink channel, or the like may be read as a side channel.

Similarly, the mobile station in the present disclosure may be read as a base station. In this case, the base station may have the function of the mobile station.

A radio frame may be composed of one or more frames in the time domain.

Each frame or frames in the time domain may be referred to as a subframe. A subframe may be further configured by one or more slots in the time domain.

The subframe may have a fixed time length (e.g., 1 ms) that does not depend on the numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. PDSCH (or PUSCH) transmitted in time units greater than the minislot may be referred to as PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one of the sub-frame and TTI may be a sub-frame (1 ms) in the existing LTE, a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. The number of slots (minislot number) constituting the minimum time unit of the scheduling may be controlled. TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain.

The number of subcarriers included in RB may be, for example, twelve, and the same regardless of the topology. The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by an index of the RB based on the common reference point of the carrier. PRB may be defined in BWP and numbered within that BWP.

BWP may include UL BWP (UL BWP) and DL BWP (DL BWP). One or a plurality of BWPs may be set in one carrier for the UE.

At least one of the configured BWPs may be active, and the UE may not expect to send and receive certain signals/channels outside the active BWP. Note that “cell”, “carrier”, and the like in this disclosure may be read as “BWP”.

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access”. In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

The “means” in the configuration of each apparatus may be replaced with “unit”, “circuit”, “device”, and the like.

Any reference to an element using a designation such as “first”, “second”, and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining” and “determining” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. That is, “judgment” or “decision” may include regarding some action as “judgment” or “decision”. Moreover, “judgment (decision)” may be read as “assuming”, “expecting”, “considering”, and the like.

In the present disclosure, the term “A and B are different” may mean “A and B are different from each other”. It should be noted that the term may mean “A and B are each different from C”.

Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 radio communication system
20 E-UTRAN
30 NG RAN
100A eNB
100B gNB
110 radio communication unit
120 RRC processing unit
130 DC processing unit
140 control unit
200 UE
210 radio communication unit
220 RRC processing unit
230 DC processing unit
240 control unit
1001 processor
1002 memory
1003 storage
1004 communication device
1005 input device
1006 output device
1007 bus

1. A terminal comprising:
a transmission/reception unit that transmits and receives messages of a radio resource control layer, wherein
the transmission/reception unit transmits dual connectivity information including a reconfiguration message of the radio resource control layer to a network in a procedure for adding or changing a secondary cell.

2. A terminal comprising:
a transmission/reception unit that transmits and receives messages of a radio resource control layer, wherein
the transmission/reception unit transmits another message of the radio resource control layer including a reconfiguration message of the radio resource control layer to a network in a procedure for adding or changing a secondary cell.

3. The terminal of claim 1 wherein the transmission/reception unit:
receives a message of the radio resource control layer including identification information of the secondary cell or a radio base station forming the secondary cell; and
transmits the dual connectivity information including the identification information.

4. The terminal of claim 2, wherein the transmission/reception unit:
receives a message of the radio resource control layer including identification information of the secondary cell or a radio base station forming the secondary cell; and
transmits another message of the radio resource control layer including the identification information.

5. A radio communication system including a terminal and a radio base station, wherein
the terminal comprises:
a transmission/reception unit for transmitting and receiving a message of a radio resource control layer, wherein
the transmission/reception unit transmits dual connectivity information including a reconfiguration message of the radio resource control layer to the radio base station in a procedure for adding or modifying a secondary cell, and
the radio base station comprises a reception unit that receives the dual connectivity information.

6. A radio communication system including a terminal and a radio base station, wherein
the terminal comprises:
a transmission/reception unit that transmits and receives messages of a radio resource control layer, wherein
the transmission/reception unit transmits another message of the radio resource control layer including a reconfiguration message of the radio resource control layer to the radio base station in a procedure for adding or changing a secondary cell, and
the radio base station comprises a reception unit that receives the another message.
